(19) United States
(12) Patent Application Publication
(10) Pub. No.: US 2006/0053640 A1
(43) Pub. Date: Mar. 16, 2006

(54) Windshield glue penetration device

(76) Inventor: Chun Po Huang, Taiching City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/983,600

(22) Filed: Nov. 9, 2004

(30) Foreign Application Priority Data
Sep. 13, 2004 (TW) 093214588

(51) Int. Cl. B26F 1/00

(52) U.S. Cl. 30/366

(57) ABSTRACT

A windshield glue penetration device includes a handle and a shank is fixed to the handle. A tip end is defined in the remote end of the shank and includes a hole defined radially therethrough. A retractable sleeve assembly has one end fixed to the handle and the shank is enclosed by the retractable sleeve assembly. A protection tube is slidably mounted to the shank and supported by a distal end of the retractable sleeve assembly. The protection tube encloses the tip end when the retractable sleeve assembly is in extended position. The protection tube is slid backward when the tip end penetrates through the glue.

### FIELD OF THE INVENTION

The present invention relates to a windshield glue penetration device which includes retractable protection tubes so as to provide sufficient structural strength when penetrating through the windshield glue.

### BACKGROUND OF THE INVENTION

A conventional way to remove the windshield of vehicles is disclosed in FIG. 1 and generally includes a wire or jig saw 20 which extends through the glue 12 which connects the periphery of the windshield glass 11 to the windshield pillars. Two handles 30 are connected to two ends of the jig saw 20 and the user holds the two handles 30 to cut the glue 12 and remove the windshield glass 11 from the vehicle. In order to penetrate the jig saw 20 through the glue 12, a tool as shown in FIG. 2 is used which includes a handle 41 and a shank 42 which is a tapered and flat board and a recess 43 is defined in a distal end of the shank 42. The jig saw 20 is inserted in the recess 43 and penetrates through the glue together with the penetration of the shank 42. After the shank 42 penetrates through the glue 12, the user pulls and removes the shank 42 and leaves the jig saw 20 at position. The two handles 30 are then connected to the two ends of the jig saw 20 and the user holds the two handles 30 to cut the windshield glass 11 from the vehicle.

FIG. 3 shows another tool for penetrating the jig saw through the glue, and includes a handle 51 and a shank 52 which includes an angled section and a penetration section 53 with a hole 54 is connected to the penetration section 53. The jig saw is then positioned in the hole 54 and extends through the glue. However, both of the tools tend to be bent or broken because of the resistance when penetrating through the glue.

FIG. 4 shows yet another tool which includes a handle 61 with a shank 62 which includes a circular cross section and a tip end 63 is defined in the distal end of the shank 62. A hole 64 is defined in the tip end 63 so as to position the jig saw. Although the length of the shank 62 is shorter than that of the previous mentioned tools and is strong enough not to be bent during penetration. The short shank 62 makes it not convenient to operate when the penetration position is proceeded at positions close to the dashboard as shown in FIG. 5.

The present invention intends to provide a reinforcement tool that includes retractable sleeves and the shank is enclosed by the sleeves such that the shank does not bend during penetration.

### SUMMARY OF THE INVENTION

The present invention relates to a windshield glue penetration device which comprises a handle with a shank fixed thereto and the shank has a tip end which has a hole defined radially therethrough. A retractable sleeve assembly includes a first sleeve and a second sleeve. The first sleeve has a first end thereof fixed to the handle and the second sleeve is retractably connected to a second end of the first sleeve. The shank is enclosed by the retractable sleeve assembly when the second sleeve is in extended position. The tip end of the shank is exposed beyond the second sleeve.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the glue on the windshield glass is cut by using a jig saw;

FIG. 2 shows a conventional windshield glue penetration device;

FIG. 3 shows another conventional windshield glue penetration device;

FIG. 4 shows yet another conventional windshield glue penetration device;

FIG. 5 shows the conventional windshield glue penetration device in FIG. 4 is used close to the dashboard;

FIG. 6 shows the windshield glue penetration device of the present invention;

FIG. 7 shows a cross sectional view of the windshield glue penetration device in FIG. 6;

FIG. 7A is a cross sectional view to show the connection of the shank, the first sleeve and the handle of the windshield glue penetration device of the present invention;

FIG. 8 shows the retractable sleeve assembly is in extended position, and

FIG. 9 shows the protection sleeve is pushed downward by the windshield glue when penetrating.

### DETAILED DESCRIPTION OF THE PREFERRED EMBODIMENT

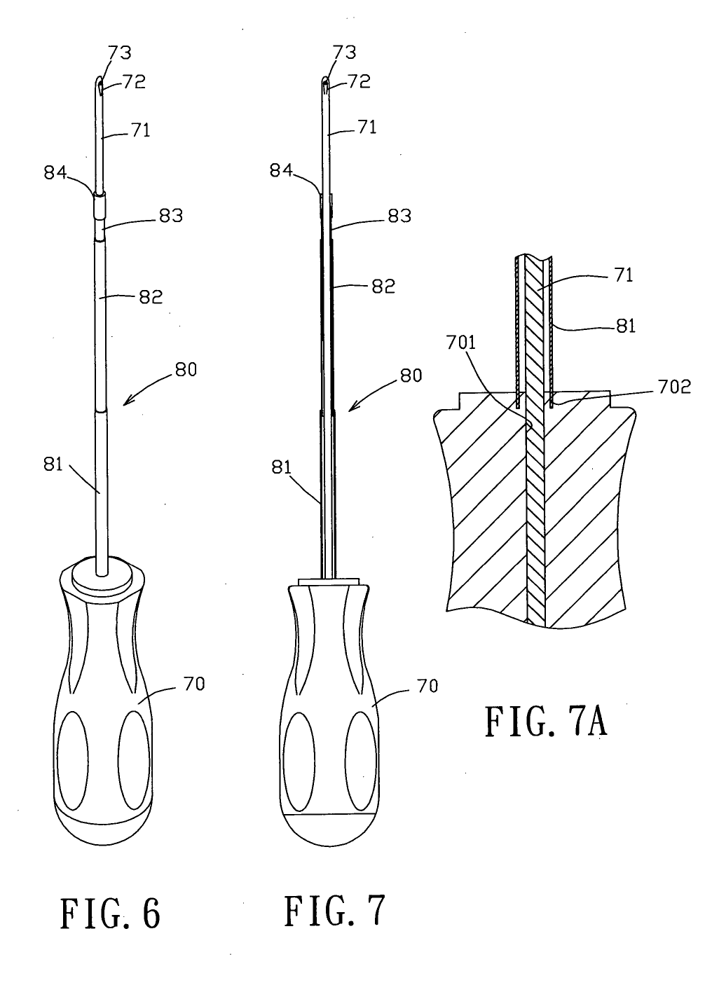

Referring to FIGS. 6 to 9, the windshield glue penetration device of the present invention comprises a handle 70 which includes a first recess 701 and a second recess 702 defined in an end surface thereof as shown in FIG. 7A, wherein the second recess 702 is an annular recess. The first recess 701 is deeper than the second recess 702. A shank 71 with a circular cross section has one end thereof fixed in the first recess 701 and a tip end 73 is defined in the other end of the shank 71. A hole 72 is defined radially through the tip end 73.

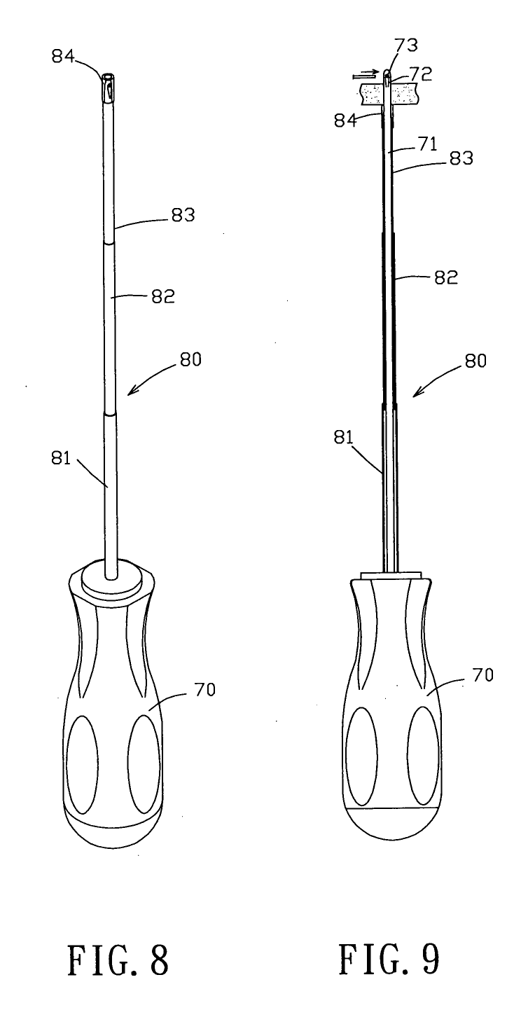

A retractable sleeve assembly 80 includes a first sleeve 81, a second sleeve 82 and a third sleeve 83. The first end of the first sleeve 81 is fixed in the second recess 702, the second sleeve 82 is retractably connected to a second end of the first sleeve 81, and the third sleeve 83 is retractably connected to the second sleeve 81. The shank 71 is enclosed by the retractable sleeve assembly 80 when the second sleeve 81 is in extended position as shown in FIG. 8, and the tip end 73 of the shank 71 is exposed beyond the second sleeve 82. A protection tube 84 is slidably mounted to the shank 71 and is sized such that it is supported by the third sleeve 82. The protection tube 84 encloses the tip end 73 as shown in FIG. 8 when the device is not in use.

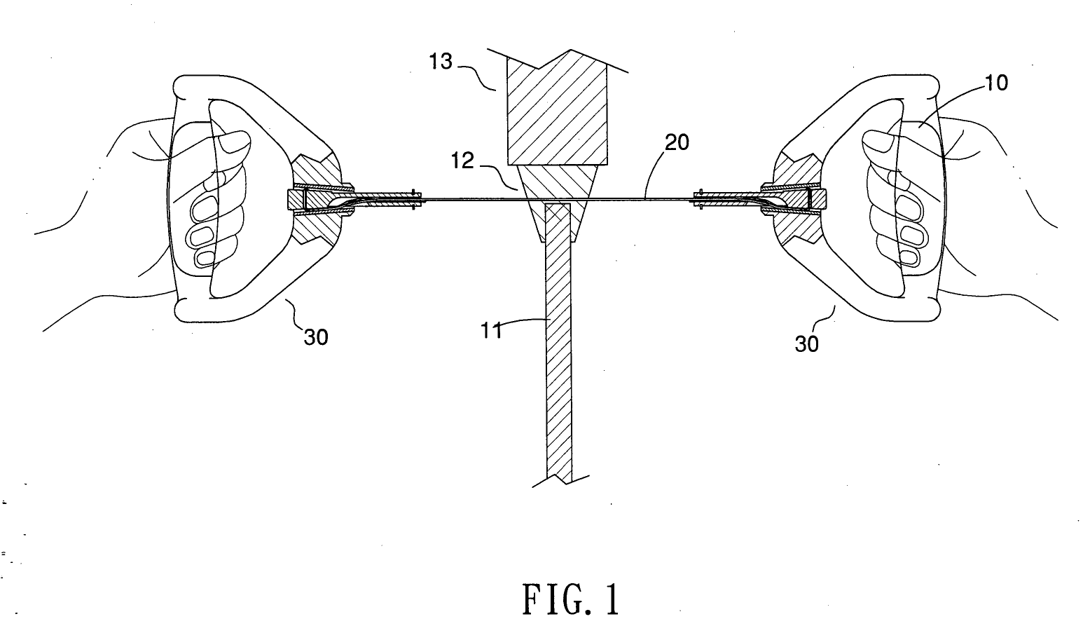

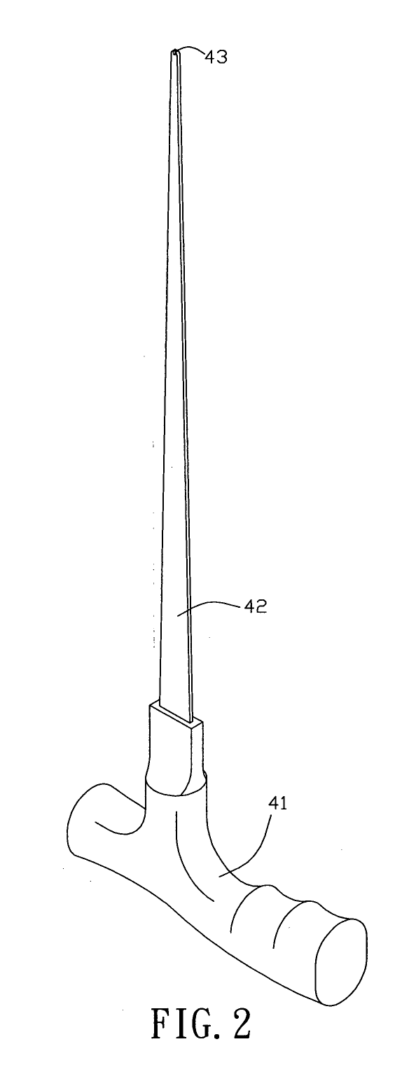

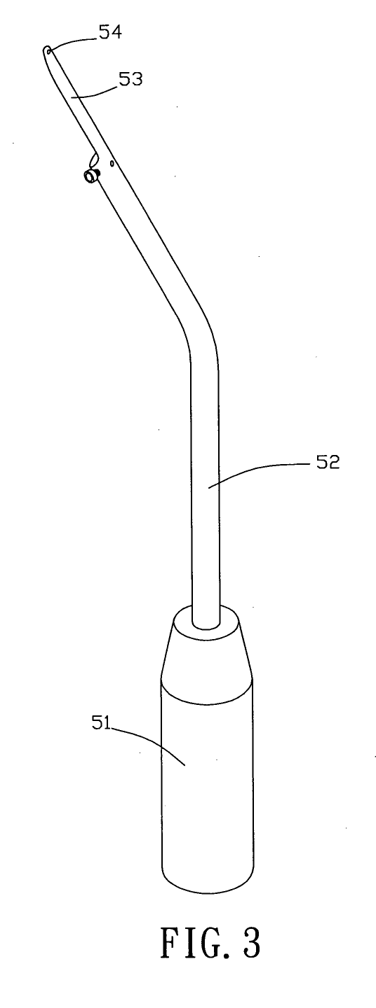

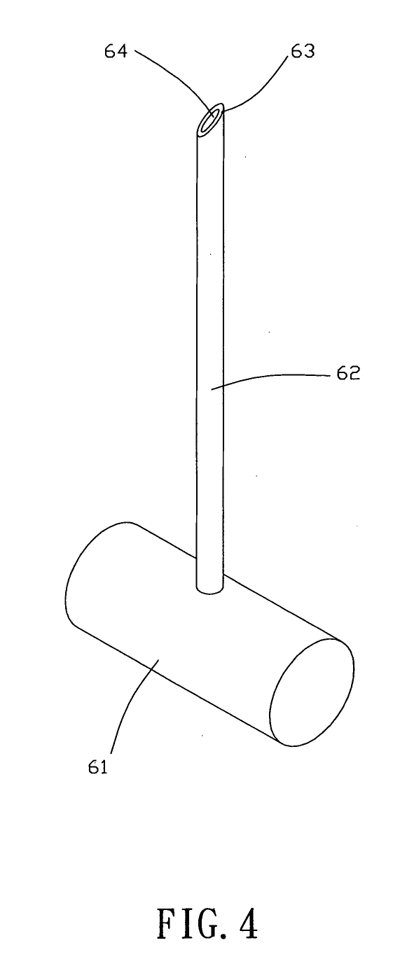

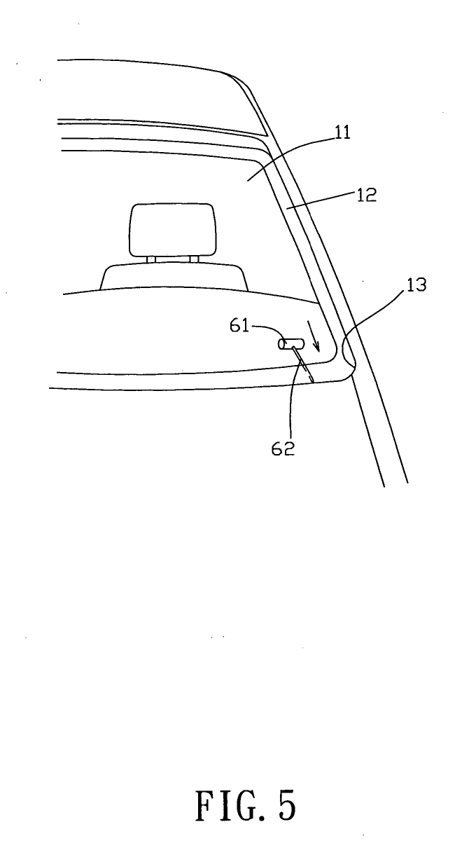

As shown in FIG. 9, when the tip end 73 penetrates through the glue, the protection tube 84 is pushed downward by the glue and the third sleeve 83 is retracted into the second sleeve 82. The jig saw (not shown) moves through the glue with the penetration of the tip end 73 and is used as described regarding to FIG. 1.

The shank 71 is enclosed by the retractable sleeve assembly 80 so that it is reinforced and not bent by the resistance.

While we have shown and described the embodiment in accordance with the present invention, it should be clear to those skilled in the art that further embodiments may be made without departing from the scope of the present invention.

What is claimed is:

1. A windshield glue penetration device comprising:
a handle;
a shank having one end fixed to the handle and a tip end defined in the other end of the shank, a hole defined radially through the tip end;
a retractable sleeve assembly including a first sleeve and a second sleeve, the first sleeve having a first end thereof fixed to the handle and the second sleeve being retractably connected to a second end of the first sleeve, the shank being enclosed by the retractable sleeve assembly when the second sleeve is in extended position.

2. The device as claimed in claim 1, wherein the handle includes a first recess and a second recess which is an annular recess, the shank fixed in the first recess and the first end of the first sleeve fixed in the second recess, the first recess being deeper than the second recess.

3. The device as claimed in claim 1 further comprising a protection tube slidably mounted to the shank and supported by the second sleeve, the tip end of the shank being exposed beyond the second sleeve and the protection tube enclosing the tip end.

4. The device as claimed in claim 1, wherein the shank has a circular cross section.
